(19) United States
(12) Patent Application Publication
(10) Pub. No.: US 2009/0004056 A1
(43) Pub. Date: Jan. 1, 2009

(54) Clinical Sample Analysis System Having An Analyzer Positioning Mechanism

(75) Inventor: Dennis A. Clement, Vacaville, CA (US)

Correspondence Address: DADE BEHRING INC.;LEGAL DEPARTMENT, 1717 DEERFIELD ROAD, DEERFIELD, IL, 60015, US

(73) Assignee: DADE BEHRING INC., Deerfield, IL (US)

(21) Appl. No.: 11/768,411

(22) Filed: Jun. 26, 2007

(51) Int. Cl. G01N 35/02

(52) U.S. Cl. 422/63

(57) ABSTRACT

A clinical sample analysis system having an analyzer positioning mechanism for providing height adjusting and horizontal alignment between an analyzing module and a clinical workstation using cradle beams and rolling ball transfer positioners.

### FIELD OF THE INVENTION

The present invention relates to an automated clinical sample handling workstation with independent analyzers having samples supplied thereto by an automated conveyor system. More particularly, the present invention relates to a device for facilitating the installation of an analyzer equipped to interact with such a sample handling workstation.

### BACKGROUND OF THE INVENTION

Clinical diagnostic analyzers are being developed with increasing levels of complexity and sophistication in order to fully automated the performance of chemical assays and immunoassays of biological fluid samples such as urine, blood serum, plasma, cerebrospinal liquids and the like, these fluid samples almost universally being contained in open or capped sample tubes. Generally, chemical reactions between an analyte in a patient's biological sample and reagents used during performing the assay result in generating various signals that can be measured by the analyzer. From these signals the concentration of the analyte in the sample may be calculated.

A wide variety of automated chemical analyzers are known in the art and are continually being improved to increase analytical menu and throughput, reduce turnaround time, and decrease requisite sample volumes. Such improvements, while necessary in themselves, may be hampered if sufficient corresponding advances are not made in the areas of pre-analytical sample preparation and handling operations like sorting, batch preparation, centrifugation of sample tubes to separate sample constituents, cap removal to facilitate fluid access, and the like.

Automated sample preparation systems are commercially available and these generally include the use of conveyor systems for conveying specimens to clinical analyzers, such as those described in U.S. Pat. Nos. 5,178,834 and 5,209,903. A disadvantage of many of these conveyor systems is that they are an integrated and dedicated part of a total integrated system, which system includes special analyzers and other handling equipment. More universal sample handling systems have more recently been introduced, like that described in U.S. Pat. No. 6,060,022 or in U.S. Pat. No. 6,984,527 incorporated herein in its entirety by reference and these “work cells” or “work stations” are adapted to automatically treat clinical samples and to then present pre-treated samples in open containers to robotic devices operated in conjunction with independent stand-alone analyzers.

U.S. Pat. No. 6,261,521 discloses a sample analysis system having a plurality of analyzers placed along a main conveyor line in combination with different types of reagent supply units, such that samples to be tested are assigned to an analyzer having the proper reagent.

U.S. Pat. No. 6,019,945 discloses a transfer mechanism for transferring a sample container holder between a conveyor line and a sampling area formed in each of several analyzers, the transfer mechanism being connectable to each one of the plurality of analyzers. At least two analyzers units are different from one another in either the types of reagent supply means, the number of analysis items that can be analyzed, the number of tests that can be processed in a unit time, or the species of samples to be processed.

U.S. Pat. No. 5,087,423 discloses a plurality of analyzing modules, a plurality of analyzing routes and at least one bypass route bypassing at least one analyzing module are arranged. Each analyzing module is capable of analyzing samples with respect to one or more items, and samples successively supplied from the introduction sides of the modules are selectively delivered into each module.

Although these prior art systems have advanced sample handling and processing throughput, what has not been addressed are the difficulties associated with properly adjusting and aligning an analyzing module that is to be placed along a conveyor line in a manner that allows for automated transfer of a sample container holder or of a liquid sample between a conveyor line and a sampling area or sample tube formed in the analyzing module.

### SUMMARY OF THE INVENTION

The present invention provides a device to facilitate the proper height adjusting and horizontal alignment adjusting between an analyzing module that is to be placed along a conveyor line of a clinical work station.

### BRIEF DESCRIPTION OF THE DRAWINGS

For a better understanding of the invention as well as other objects and further features thereof, reference is made to the following detailed description of various preferred embodiments thereof, taken in connection with the accompanying drawings wherein:

FIG. 1 is a simplified front elevation view of a cradle beam portion of the present invention;

FIG. 2 is a simplified top plan view of the cradle beam portion of FIG. 1;

FIG. 3 is a simplified side elevation view of the cradle beam portion of FIG. 1;

FIG. 4 illustrates a first cradle beam of FIG. 1 and a second, mirror-image cradle beam portion mutually aligned with a connecting bar therebetween;

FIG. 4A is a simplified side elevation view of the cradle beam portions of FIG. 4 with the connecting bar therebetween;

FIG. 5 is a simplified side elevation view of the cradle beam portions of FIG. 4 partially assembled with the connecting bar of FIG. 4;

FIG. 5A is a simplified side elevation view of the cradle beam portions of FIG. 4 fully assembled with the connecting bar of FIG. 4;

FIG. 6 is a side elevation view of a ball transfer positioner suitable for horizontally positioning the assembled cradle beam structure of FIG. 5A;

FIG. 6A is a plan view of a ball transfer plate of FIG. 6;

FIG. 7 is an enlarged side elevation view of a single ball transfer portion of the ball transfer positioner of FIG. 6; and,

FIG. 8 is a side elevation view of the ball transfer positioner of FIG. 6 further adapted for vertically positioning the assembled cradle beam structure of FIG. 5A;

FIG. 9 is a side elevation schematic view of an analyzing module supported by the height and horizontal adjusting mechanism of the present invention and illustrating the capability to automatically provide height adjustment and horizontally alignment between the analyzing module and a conveyor line of a clinical workstation; and,

FIG. 10 is a plan schematic view of the height and horizontal adjusting mechanism of FIGS. 9

### DETAILED DESCRIPTION OF THE PREFERRED EMBODIMENTS

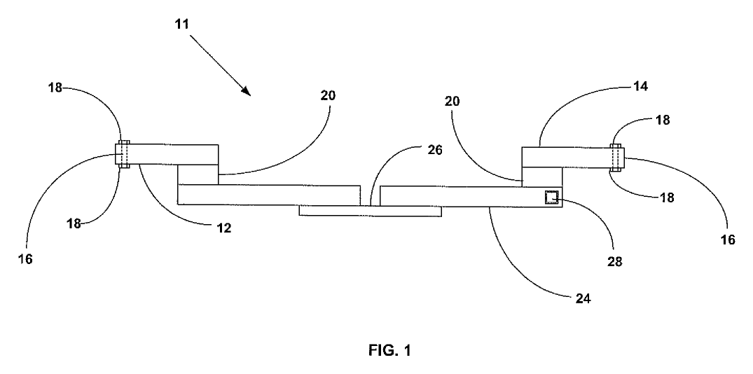

FIG. 1 illustrates a cradle portion of the analyzer adjusting mechanism 10 of the present invention (shown assembled in FIG. 10) for positioning an analyzing module relative to a clinical workstation. As described herein, analyzer adjusting mechanism 10 is capable of automatically facilitating the proper height adjusting and horizontal alignment adjusting between an analyzing module that is to placed along a conveyor line of a clinical workstation. Adjusting mechanism 10 comprises a cradle beam 11 having generally rectilinear left and right flange members 12 and 14, respectively, attached to generally rectilinear left and right support beams 22 and 24, respectively, by means of a pair of generally rectilinear left and right spacing members 20 positioned between left and right flange members 12 and 14 and left and right support beams 22 and 24. A connecting bar 26 attaches left and right support beams 22 and 24 so that adjusting mechanism 10 comprises generally rectilinear supporting cradle beam 11.

The distal end of each left and right flange member 12 and 14 have an open bore 16 extending vertically therethrough with a pair of hex nuts 18 attached to flange member 12 and 14 at the upper and lower openings of bores 16.

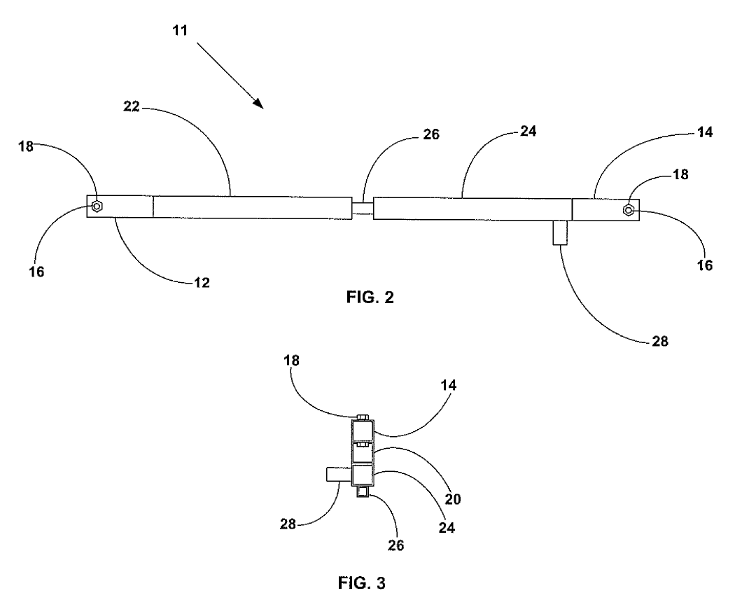

FIG. 2 is a top plan view of cradle beam 11 further illustrating an important feature of the present invention as being a connecting stud 28 infixed perpendicularly to right support beam 24 at a location generally above right spacing member 20. FIG. 2 also illustrates how left and right flange members 12 and 14, left and right support beams 22 and 24, left and right spacing members 20, connecting bar 26, open bore 16 and hex nuts 18 are assembled in a generally centrally aligned manner. FIG. 3 is a right elevation view of cradle beam 11 illustrating how left and right flange members 12 and 14, left and right support beams 22 and 24, left and right spacing members 20 and connecting bar 26, open bore 16 and hex nuts 18 are further assembled in a generally vertically aligned manner.

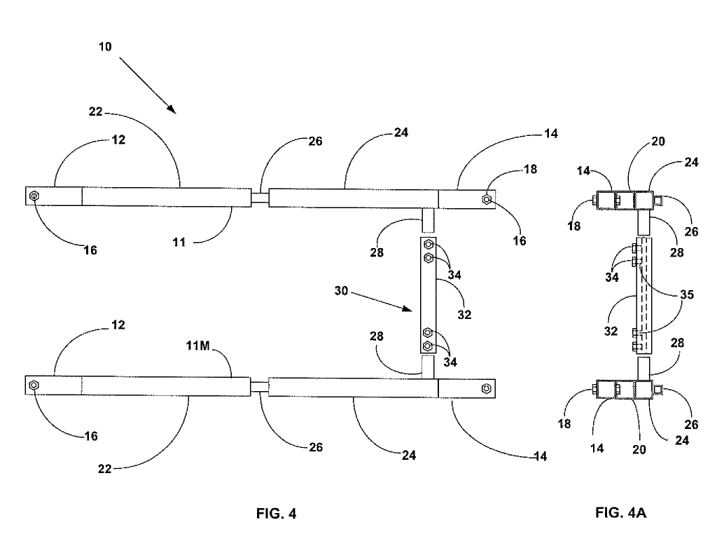

FIG. 4 illustrates a first cradle beam 11 and a second, mirror-image cradle beam 11 M mutually aligned parallel with one another with a connecting member 30 arranged perpendicularly thereto. Connecting member 30 comprises an open, connecting bar 32 having two pairs of hex nuts 34 affixed at opposing ends thereof, each hex nut 34 aligned with a machined hole 35 (FIG. 4A) through the connecting bar 32. FIG. 4A is a simplified side elevation view of the cradle beam 11 of FIG. 4 with the inner portion of connecting bar 32 illustrated in dashed lines and exaggerated in dimension for the purposes of showing machined holes 35, also illustrated in dashed lines

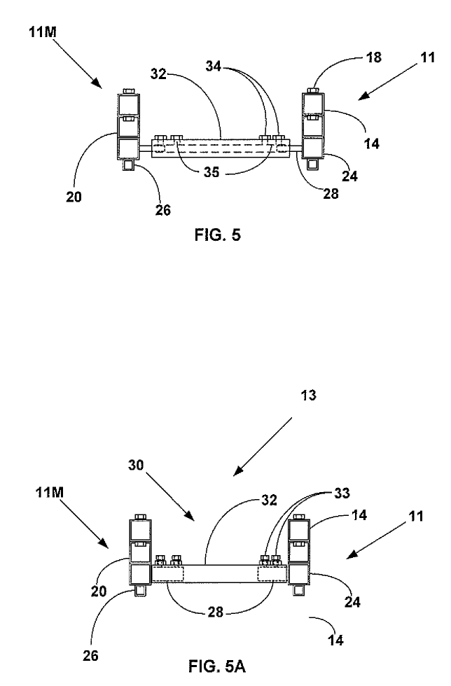

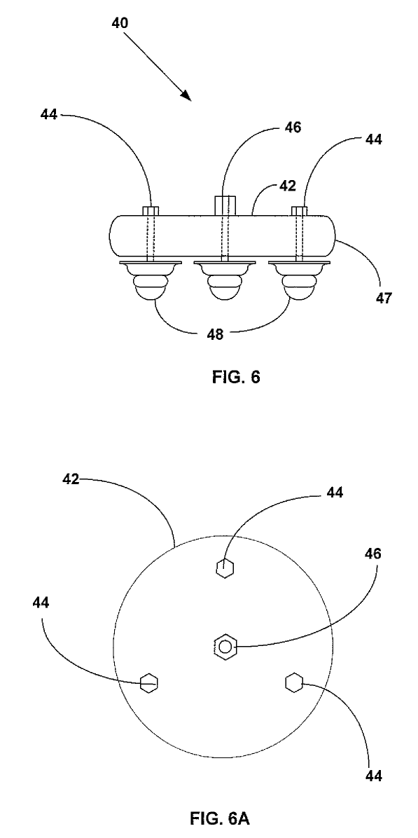

FIG. 5 is a side elevation view of the connecting studs 28 of first cradle beam 11 and second, mirror-image cradle beam 11M partially inserted into opposed ends of open connecting bar 32. FIG. 5A is a side elevation view of the of the connecting studs 28 of cradle beam portions 11 and 11M fully assembled into connecting bar 32 and having threaded hex bolts 33 screwed through hex nuts 34 so that connecting member 30 securely attaches cradle beam 11 and second, mirror-image cradle beam 11M together, thereby forming a cradle beam structure 13 portion of height and horizontal adjusting mechanism 10.

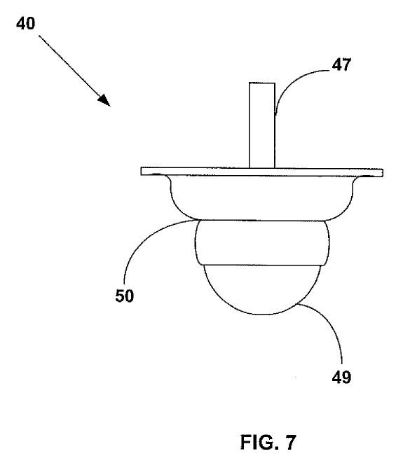

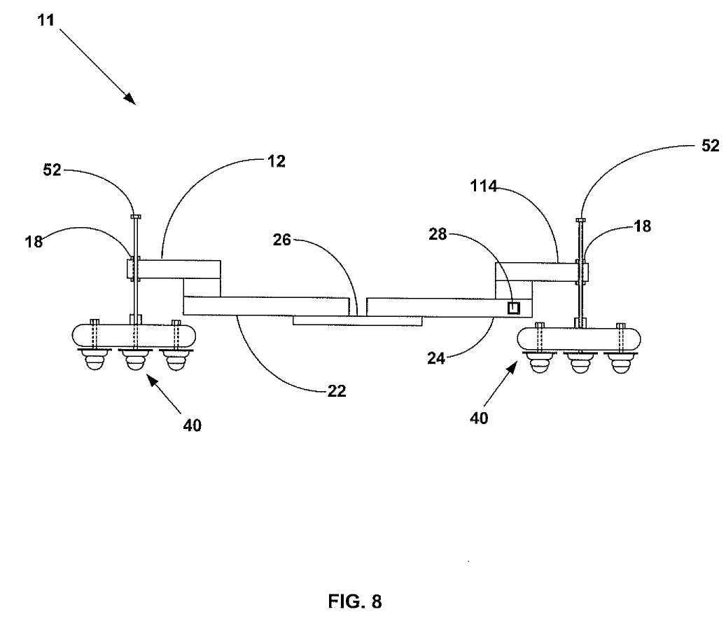

FIG. 6 is a side elevation view of a ball transfer positioner 40 suitable for horizontally positioning the assembled cradle beam structure 13, ball transfer positioner 40 comprising a generally circular plate 42 having a number of stud-mounted rolling ball casters 48 affixed thereto by means of studs 47 inserted through openings in plate 42 and into a corresponding number of radially displaced hex nuts 44. FIG. 6A is a plan view of circular plate 42 and illustrates an additional threaded hex nut 46, centrally located on plate 42 as well as how the radially displaced threaded hex nuts 44 are uniformly distributed on plate 42. FIG. 7 is an enlarged side elevation view of a single ball transfer portion 48 of the ball transfer positioner 40 as seen comprising a rolling ball 49 attached to stud 47 with a conventional bearing housing 50.

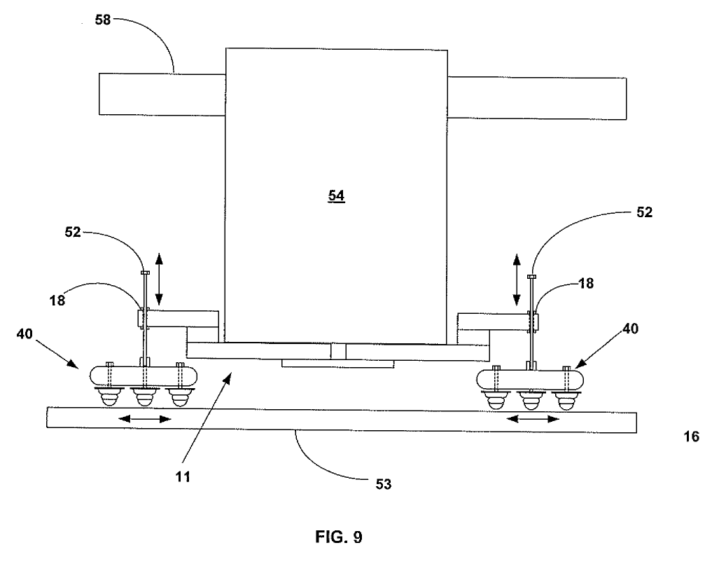

FIG. 8 is a side elevation view of the rolling ball caster 48 being further adapted for vertically positioning the assembled cradle beam 11 by means of thread rod 52 threaded through hex nuts 18 attached to flange members 12 and 14 at the upper and lower openings of bores 16 and into the central hex nut 46 of ball transfer positioner 40. It is clear to one skilled in the art that thread rod 52 can be rotated within hex nuts 18 so as to vertically raise or lower cradle beam 1 1 relative to ball transfer positioner 40.

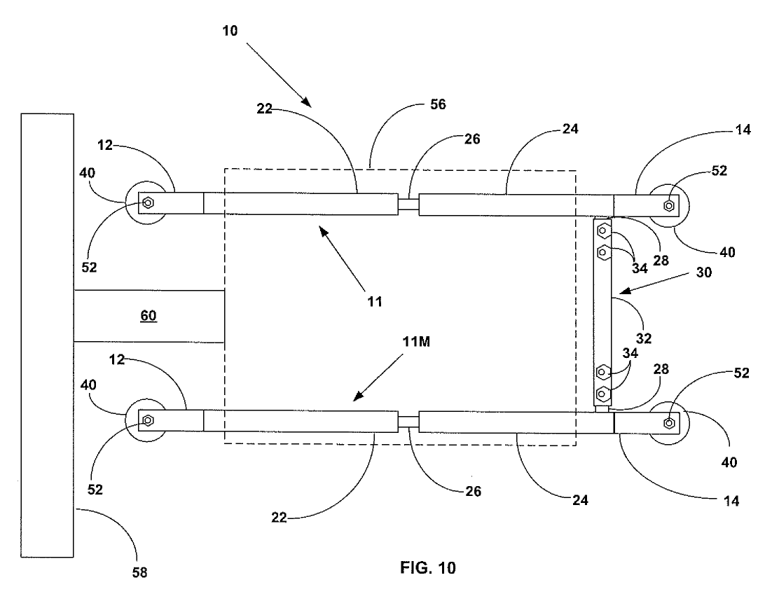

FIG. 9 is a schematic elevation view of a piece of analyzing module 56 supported by assembled cradle beam 11 and illustrating the analyzer adjusting mechanism 10 of the present invention as being capable of automatically providing height adjustment and horizontally alignment between the analyzing module 56 and a conveyor pathway 58 of a clinical workstation 60 like that disclosed in U.S. Pat. No. 6,984,527, incorporated herein in entirely by reference, capable of transporting sample containers along a pathway proximate at least one sample analyzing module 56, like that disclosed in U.S. Pat. No. 7,015,042 also incorporated herein in entirety by reference, capable of analyzing a clinical sample. The rolling property of ball transfer positioner 40 along flooring 53, indicated by a pair of horizontal arrows, provides horizontally alignment between the analyzing module 56 and conveyor line 58 and rotation of thread rod 52 within hex nuts 18 and into ball transfer positioner 40 provides vertical alignment between the analyzing module 56 and conveyor pathway 58. It is clear to one skilled in the art that in a preferred embodiment, an assembled cradle beam structure 13 having first cradle beam 11 and second, mirror-image cradle beam 11 M secured by connecting member 30 like seen in FIG. 5A, would be used to securely support analyzing module 56 and be capable of automatically providing height adjustment and horizontally alignment between the analyzing module 56 and a conveyor pathway 58 of a clinical workstation 60. This is schematically illustrated in FIG. 10, a plan view of analyzing module 56 supported by the height and horizontal adjusting mechanism 10 of the present invention as adapted for automatically providing height adjustment and horizontally alignment between the analyzing module 56 and a conveyor line 58 of a clinical workstation 60, the analyzing module 56 shown in dashed lines for purposes of clarity. FIG. 10 also illustrating a sample transfer mechanism 60 capable of transferring sample to be analyzed by analyzing module 56 transported by conveyor pathway 58 to a location proximate analyzing module 56 and providing the sample container or portion of sample carried therein to analyzing module 56.

In practical operation, the analyzing module 56 would be positioned proximate conveyor line 58 and then first cradle beam 11 and second, mirror-image cradle beam 11M would be placed below analyzing module 56 and then secured together with connecting member 30. Typically, module 56 would have integrated supports so that cradle beams 11 and 11M are easily placed therebelow. Clearly, connecting member 30 and cradle beams 11 and 11M would have lengths selected appropriate for the dimensions of the analyzing module 56 to be aligned with conveyor line 58. Next, four ball transfer positioners 40 would be assembled to cradle beams 11 and 11M using thread rod 52 and thread rod 52 rotated so as to lift analyzing module 56 off its integrated supports and above flooring 53. Then, analyzing module 56 would be rolled on ball transfer positioners 40 into horizontal alignment with conveyor line 58 and finally, thread rod 52 rotated so as to vertically align analyzing module 56 with conveyor line 58.

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A clinical sample analysis system comprising:
a sample analyzing module capable of analyzing a clinical sample;
a clinical workstation capable of transporting sample containers along a pathway proximate said sample analyzing module;
a sample transfer mechanism capable of transferring said sample container from said conveyor to said analyzing module; and, an analyzer adjusting mechanism capable of positioning said analyzing module relative to said clinical workstation

2. The clinical sample analysis system of claim 1 wherein said sample transfer mechanism is adapted to transfers a portion of sample carried in said sample container to said analyzing module.

3. The clinical sample analysis system of claim 1 wherein said analyzer adjusting mechanism supports said analyzing module.

4. The clinical sample analysis system of claim 3 wherein said analyzer adjusting mechanism automatically provides height and horizontal alignment between said analyzing module and said pathway.

5. The clinical sample analysis system of claim 4 wherein said analyzer adjusting mechanism comprises first and second cradle beams mutually aligned parallel with one another with a connecting member perpendicularly securing said beams together,

6. The clinical sample analysis system of claim 5 wherein said beams have generally rectilinear and identical left and right flange members with threaded nuts affixed at openings extending therethrough.

7. The clinical sample analysis system of claim 6 further comprising a ball transfer positioner attached to each of the left and right flange members.

8. The clinical sample analysis system of claim 7 wherein said ball transfer positioner comprises a generally circular plate with a centrally located threaded nut and a number of stud-mounted rolling ball casters affixed thereto.

9. The clinical sample analysis system of claim 8 wherein said ball transfer positioners are attached to said left and right flange members by a thread rod screwed into said threaded nut and into threaded nuts affixed to said left and right flange members.

10. The clinical sample analysis system of claim 5 wherein said connecting member comprises an open bar and said cradle beams further comprise a connecting stud affixed perpendicularly thereto and sized to be secured within said open bar.

11. The clinical sample analysis system of claim 9 wherein rotation of said thread rod provides vertical movement between said ball transfer positioners and said left and right flange members.

12. The clinical sample analysis system of claim 9 wherein each ball transfer positioner comprises a rolling ball adapted to provide horizontal movement along a support floor.
